(19) United States
(12) Patent Application Publication
(10) Pub. No.: US 2010/0001109 A1
(43) Pub. Date: Jan. 7, 2010

(54) COLLECTION CONTAINER FOR A FILE SHREDDER

(76) Inventor: Hermann Schwelling, Salem (DE)

Correspondence Address: COLLARD & ROE, P.C., 1077 NORTHERN BOULEVARD, ROSLYN, NY, 11576, US

(21) Appl. No.: 12/449,229

(22) PCT Filed: Jan. 29, 2008
(86) PCT No.: PCT/EP2008/000649

§ 371 Date: Jul. 29, 2009

(30) Foreign Application Priority Data
Jan. 30, 2007 (DE) 10 2007 006 315.8

(51) Int. Cl. B02C 18/00

(52) U.S. Cl. 241/100

(57) ABSTRACT

The invention relates to a collection container for a paper shredder, the container being removably arranged in an interior that is open to one side and located below a cutting mechanism in the housing of the paper shredder or a similar device. The invention is characterized in that a front wall of the collection container is associated with a profiled front part and is connected to the same in at least some sections.

The invention relates to a collection container for a file shredder, which container is removably disposed in an interior of a housing and below a cutting mechanism of the file shredder.

File shredders for shredding data carrier material in the form of documents in sheet form, CDs, microfilms, diskettes, and similar materials, are known in the most varied embodiments and performance classes.

According to one type, the collection receptacles are configured as a collection container, often also called a paper basket or collection basket. The front surface of such collection containers, in other words the surface that points toward the user, is simultaneously integrated into the front surface of the file shredder in the case of many types, in other words the two narrow face surfaces of the side walls of the housing of the file shredder and the front surface of the collection container form the front surface of the file shredder.

For quite some time, the said collection containers have been made from plastic. In order to keep both production costs and transport costs low, these collection containers are subject to constant optimization, particularly also with regard to reducing the thickness of the body walls. However, this has the result, particularly in the upper open region of the collection container, that it becomes unstable. If handled carelessly when it is removed from the housing, for the purpose of emptying out the collected material, and when it is set back into the housing, damage to the collection container itself and to the narrow face surfaces of the side walls of the file shredder housing cannot always be avoided.

Also, under various circumstances, it can occur that the user puts weight on the front surface of the collection container, and in the case of the collection containers that are known up to now, this can lead to breaking of its walls. As a result of such breakage, sharp edges occur, which can cause the user to incur injuries due to cutting or tearing.

For this reason, the task of the invention consists in developing a collection container for file shredders that has increased stability but is also cost-advantageous with regard to the material and production costs, as well as the transport costs.

In the sense of the present invention, a file shredder is understood to be a device for shredding data carrier material, which can be documents in sheet form, CDs, microfilms, diskettes and similar material.

The task is accomplished, according to the invention, by means of a collection container for a file shredder having the characteristics of claim 1. The dependent claims 2 to 17 show further developments and advantageous embodiments of the invention.

According to the invention, the collection container removably disposed in an interior of the housing of the file shredder or similar device, which interior is open on one side and provided below a cutting mechanism, has a specially profiled front part assigned to it, on its front wall, which part is connected with the wall at least in certain sections. According to a further development, at least a left and a right edge region, preferably also a top edge region of the front part project laterally beyond the front wall.

The front part lies directly against the outside of the front wall with its inside, or, according to a further embodiment, the front part is disposed on the front wall with its inside at a distance from the outside, at least in certain sections.

It is furthermore advantageous if at least two strips are disposed spaced apart from one another on the inside of the front part, between which strips the front longitudinal edges of the front wall of the collection container as well as regions of the side walls close to the edge are positioned, preferably also held with a shape fit.

Furthermore, catch parts are provided in the upper region, on the inside of the front part, to hook into the front wall, as are support parts in the lower region, which engage into a perforation in the front wall, in each instance.

Specifically, the catch parts, particularly the ones provided in the upper region, engage into the front wall of the collection container in such a manner that during handling of the collection container, particularly during removal of the filled collection container, the direction of effect of the engaging force does not counteract inter-hooking, in other words in case of disadvantageous handling, the inter-hooking could come loose, as could be the case with some other embodiments of collection containers in the state of the art, for example in the case of a collection container according to DE 203 01 793 U1.

The parts of the front part that project beyond the top and sides of the collection container preferably have multiple rib-shaped crosspieces, thereby achieving additional stability in the front region.

Furthermore, a recess that preferably narrows conically extends in the front part of the collection container, symmetrical to its median plane, upward on the body, which recess projects from the lower edge all the way into the upper region and ends at a base that lies crosswise on the top.

Corresponding to the location and shape of this recess in the front part, an indentation is formed in the front wall, inward relative to the body, having a flat part and angled narrow sides.

Furthermore, it is provided that the longitudinal edges of the indentation, which are directed upward, are profiled, preferably configured in U shape, and that the shanks of the recess of the front part, which run correspondingly, each possess a nose strip, which strips are accommodated in the U profile, with shape fit, in the assembled state.

By means of at least one of the new characteristics for the configuration of a collection container as mentioned above, increased stability of the container is achieved. Further advantages result from the configuration characteristics mentioned below.

For example, according to a further development, the base of the recess in the front part, which base lies crosswise at the top, is extended inward relative to the body and, at the same time, configured as a handle depression. In connection with an adapted shaping of the upper region of the indentation in the front wall, good ergonomic configuration of the handle depression is achieved, and, at the same time, reaching into the interior of the collection container is prevented.

Furthermore, it is advantageous that the edges of the side walls of the collection container are inclined downward, starting from the front wall, toward the rear, toward the rear wall, so that introduction of the collection container into the interior is further facilitated.

Furthermore, it is provided that at least some surface sections of the collection container consist of translucent, preferably transparent material; preferably its front wall, particularly the surface part of the indentation provided in the wall.

Other advantages can be achieved in that the front part is connected with the front wall with force fit and/or shape fit; by means of being screwed, glued and/or welded together. This connection between the two parts can be provided at points, in certain sections, or throughout.

The invention will be explained in detail and further in the following, using an exemplary embodiment. In this connection, the drawing shows:

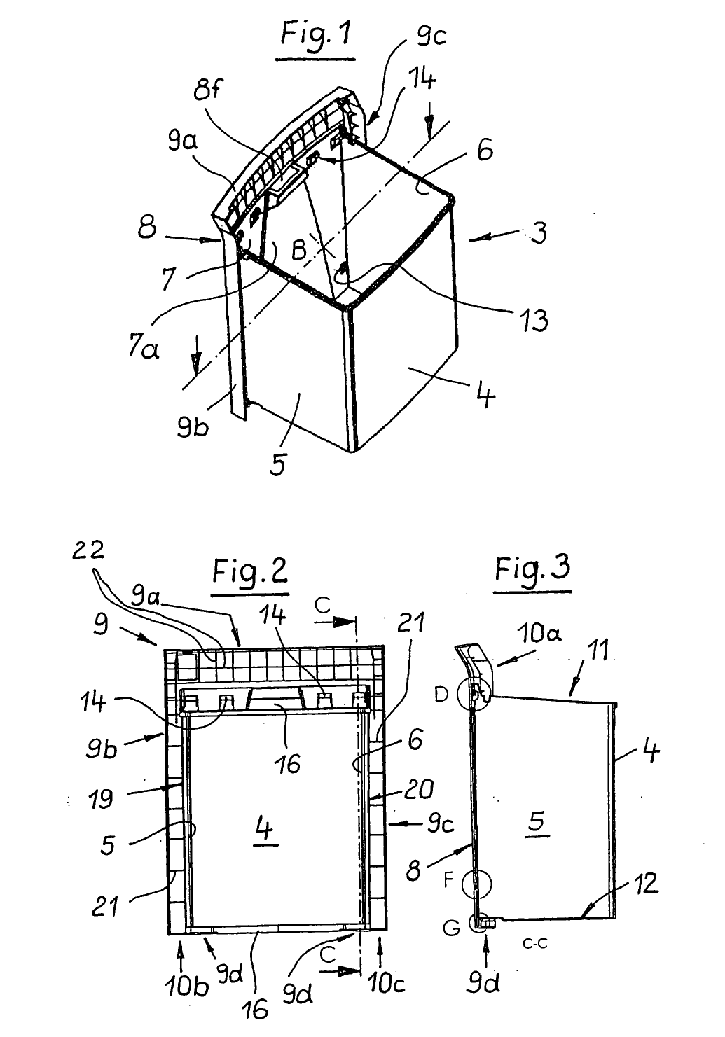

FIG. 1 a perspective view of the new collection container;

FIG. 2 a view from the rear of the collection container and the inside of its front part;

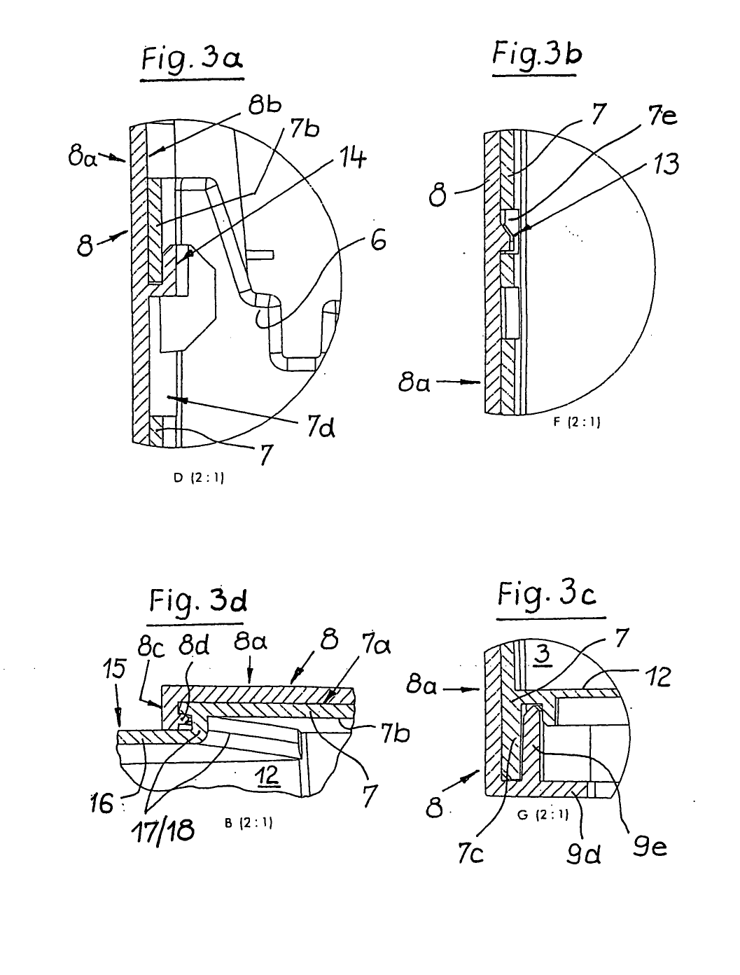

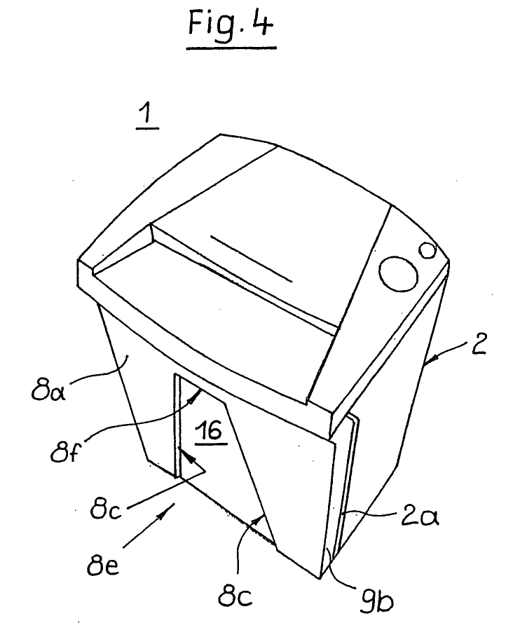

FIG. 3 a side view of the collection container according to FIG. 1;

FIG. 3a to 3d details of the connection between the front part and the collection container;

and

FIG. 4 a file shredder having the new collection container.

The collection container according to the invention is shown in different views in FIGS. 1, 2, and 3, and in detail in FIGS. 3a, 3b, 3c, and 3d. It consists of an essentially rectangular bottom 12 and walls that proceed from it, directed upward, the rear wall 4, the right side wall 5, the left side wall 6, and the front wall 7, and is preferably configured in one piece. The collection container is made from plastic. At least its front wall 7 is made of a translucent, preferably a transparent material.

According to the invention, the front wall 7 has a front part 8 assigned to it, in front of it. The front part 8, a profiled molded part, lies against the outside 7a of the front wall 7 with its inside 8b preferably in certain sections. The front part 8 is connected with the front wall 7 by means of catch parts 14 and support parts 13. The catch parts 14 pass through the front wall 7, preferably in the upper surface section. The support parts 13 pass through the front wall 7, preferably in the lower surface section.

In FIG. 2, it can be seen that the expanse of the front part 8, in terms of area, is greater than the area taken up by the front wall 7.

In this way, the result is achieved that with regard to the body of the collection container, an upper projection 10a, a right projection 10b, and a left projection 10c are formed.

On the inside 8b of the front part 8, two strips that project away from the inner surface and are at a distance from one another are disposed. Between these strips, at least the two longitudinally oriented body edges of the front wall 7 of the collection container are positioned and held with shape fit. Preferably, the regions of the side walls 5 and 6 close to the edges are also covered by these strips, with shape fit. In the region of the projections 10a, 10b, and 10c, multiple rib-like crosspieces 21 arranged crosswise are disposed on the inside 8b of the front part 8, between the strips 19 and 20, and the outer edge 9 of the right 9b and the left section 9c. Rib-like crosspieces 22 are disposed on the inside of the upper projection 10a, in the manner of a lattice.

In FIG. 3a, the engagement of the front part 8 with the front wall 7 by means of a catch strip 14 is shown once again, in detail. The front wall 7 possesses a perforation 7d there for each catch part 14. Each catch part 14 passes through a perforation 7d and lies firmly against the inside 7b of the front wall 7 with its hook part. In this representation, the catch part 14 that lies close to the side wall 6 is shown.

According to FIG. 3b, the cam-like support part 13 provided in the lower region of the front part 8, on its inside 8b, engages into a corresponding perforation 7e provided in the front wall 7. FIG. 3c shows how the front part 8 lies against the front wall 7 and is attached to it, in the lower edge region. The front wall 7 projects beyond the bottom 12 of the collection container 3, forming a tab-like crosspiece 7c. The lower section 9d of the outer edge 9 of the front part 8 is not continuous, because the recess 8e is disposed in the center. The two lower edge sections 9d that are formed as a result, which extend essentially at a right angle from the basic body surface of the front part 8, just like the upper section 9a, the right section 9b, and the left sections 9c, each possess a crosspiece 9e directed upward, which, together with the related section of the front part 8, forms a U-shaped groove, into which the tab-like crosspiece 7c of the front wall 7 is inserted. The two lower edge sections 9d therefore project beyond the bottom 12 of the collection container 3 and thus are contact surfaces for contact of the frontal front of the collection container and the related face sides of the housing 2, together with the upper projection 10a, the right projection 10b, and the left projection 10c. They are, at the same time, stops with regard to the planned positioning of the collection container 3 below the cutting mechanism of the file shredder 1 disposed in the housing 2, which shredder is shown in perspective in FIG. 4. The other reference symbols contained in FIG. 4 correspond to what has already been mentioned in the above part of the description. The inserted collection container 3 closes the opening 2a of the accommodation space in the housing 2.

In FIG. 3d, the detail concerning the indentation 15 provided in the front wall 7, inward relative to the body, is shown. This indentation 15 possesses a surface part 16 as well as narrow sides 18 on both sides, having longitudinal edges 17 that are configured in U shape and profiled. A nose strip 8d of the angled-away shanks 8c of the front part 8 engages into these U-shaped longitudinal edges 17, in each instance. The shanks 8c are also a part of the recess 8e provided in the front part 8 of the collection container 3, symmetrical to its 8 median plane, upward relative to the body. This recess 8e is configured to narrow conically upward, and reaches from the lower edge all the way to the upper region, and ends there at a base 8f that lies crosswise at the top. The recess 8e furthermore intersects the outside 8a and the inside 8b of the front part 8.

The inside 8b of the front part 8 lies against the outside 7a of the front wall 7 here.

At least the surface part 16 of the indentation 15 consists, in the case of the embodiment shown, of a translucent, preferably transparent material, and thus always allows a view into the collection container for the purpose of observing its level of filling or the quality of shredding of the material that has been input.

FIG. 3 furthermore shows that in the case of this embodiment, the upper edges 11 of the side walls 5 and 6 are inclined in the direction of the rear wall 4, proceeding from the front wall 7.

The base 8f of the recess 8e that lies crosswise at the top, see FIG. 1, is extended inward with regard to the body, thereby forming a handle depression. The upper region of the indentation 15 is furthermore shaped to be adapted to this extension, so that the handle depression is closed toward the interior of the collection container 3.

### REFERENCE SYMBOL LIST

1 file shredder
2 housing
2a opening (of the accommodation space in item 2)
3 collection container
4 rear wall
5 right side wall
6 left side wall
7 front wall
7a outside
7b inside
7c tab-like crosspiece
7d perforation (in item 7)
7e perforation (in item 7)
8 front part
8a outside
8b inside
8c shank
8d nose strip
8e recess
8f base (of item 8e)
9 outer edge
9a upper section
9b right section
9c left section
9d lower section
9e crosspiece
10a upper projection
10b right projection
10c left projection
11 inclined edges (on items 5 and 6)
12 bottom
13 support parts (cams)
14 catch parts
15 indentation
16 surface part
17 longitudinal edges
18 narrow sides
19 strip
20 strip
21 rib-like crosspieces
22 rib-like crosspieces

1. Collection container for a file shredder (1), which container is removably disposed in an interior (2a) provided in a housing (2) and below a cutting mechanism of the file shredder (1) or similar device, wherein
a front wall (7) of the collection container (3) has a profiled front part (8) assigned to it, which part is connected with the wall (7) at least in certain sections.

2. Collection container according to claim 1,
wherein
at least a left and a right edge region, preferably also a top edge region of the front part (8) project laterally beyond the front wall (7).

3. Collection container according to
claim 1 wherein
the front part (8) lies directly against the outside (7a) of the front wall (7) with its inside (8b).

4. Collection container according to
claim 1, wherein
the front part (8) is disposed on the front wall (7), at least in certain sections, at a distance from the outside (7a) with its inside (8b).

5. Collection container according to
claim 1, wherein
at least two strips (19, 20) are disposed spaced apart from one another on the inside (8b) of the front part (8), between which strips the front longitudinal edges (17) of the front wall (7) of the collection container (3) as well as regions of the side walls (5 and 6) close to the edge are positioned, preferably also held with a shape fit.

6. Collection container according to
claim 1, wherein
catch parts (14) are provided in the upper region, on the inside (8b) of the front part (8), to hook into the front wall (7).

7. Collection container according to
claim 1, wherein
support parts (13) are provided in the lower region, on the inside (8b) of the front part (8), which preferably engage into perforations (7d and 7e) in the front wall (7).

8. Collection container according to
claim 1, wherein
a recess (8e) that narrows conically extends in the front part (8), symmetrical to its vertical median plane, upward on the body, which recess projects from the lower edge (9d) into the upper region, all the way to a base (8f) that lies crosswise.

9. Collection container according to
claim 1, wherein
the edges (11) of the side walls (5 and 6) are inclined downward, starting from the front wall (7), toward the rear, toward the rear wall (4).

10. Collection container according to
claim 1, wherein
the projections (10a, 10b, and 10c) of the front part (8) that project beyond the collection container (5, 6, 7) at the top and sides have multiple rib-like crosspieces (21 or 22), in each instance.

11. Collection container according to claim 8,
wherein
a handle depression is formed on the base (8f) of the recess (8e) that lies crosswise at the top.

12. Collection container according to
claim 10, wherein
corresponding to the position and shaping of the recess (8e) in the front part (8), an indentation (15) is configured in the front wall (7), having a surface part (16) and angled-away narrow sides (18).

13. Collection container according to claim 12,
wherein
longitudinal edges (17) of the narrow sides (18), which are directed upward, are profiled, preferably configured in U shape, and wherein the shanks (8c) of the recess (8e), which run correspondingly, each possess a nose strip (8d), which strips are accommodated in the U profile of the longitudinal edges (17), with shape fit, in the assembled state.

14. Collection container according to
claim 1, wherein
the front part (8) is connected with the front wall (7) with shape fit and/or force fit.

15. Collection container according to claim 14,
wherein
the connection is produced by means of screwing, gluing and/or welding.

16. Collection container according to
claim 14, wherein
the force-fit connection between the two parts (7 and 8) of the door (1) is in point form.

17. Collection container according to
claim 1, wherein
at least surface sections of the collection container (3) consist of translucent, preferably transparent material, preferably its front wall (7), particularly its surface part (16) of the indentation (15).
